(19) United States
(12) Patent Application Publication
(10) Pub. No.: US 2012/0060746 A1
(43) Pub. Date: Mar. 15, 2012

(54) AUTOMOBILE DETERRENT DEVICE FOR BICYCLE

(76) Inventor: David E. MANDELBAUM, Providence, RI (US)

(21) Appl. No.: 13/048,652

(22) Filed: Mar. 15, 2011

Related U.S. Application Data
(60) Provisional application No. 61/314,011, filed on Mar. 15, 2010.

(51) Int. Cl. B60Q 9/00

(52) U.S. Cl. 116/28 R

(57) ABSTRACT

A device, which is attachable to a bicycle, extends out laterally from the bicycle in a direction toward or into a lane of traffic. The device may be approximately three feet in length and cylindrical in shape. The device serves as a reminder of the leeway that must be given between a bicycle and a passing car, and deters drivers of passing automobiles from encroaching within three feet of the bicycle to which the device is attached. The device is constructed of a flexible polymer material, preferably polyethylene foam. The flexible construction allows the device to flex upon impact by a passing vehicle, thereby preventing substantial effect upon the trajectory of the bicycle and preventing damage to the vehicle. The device can be designed in two parts which can separate in the unlikely event that the end becomes attached to a passing vehicle.

This application claims the benefit of U.S. Provisional Patent Application No. 61/314,011 filed Mar. 15, 2010, the entire disclosure of which is incorporated herein by reference. This application includes material, which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field bicycles, and in particular to safety devices for attachment to bicycles.

### BACKGROUND

One of the greatest dangers to bicyclists is a car passing too closely and hitting them. To address this danger, 14 states have passed legislation (with more in the process), generally referred to as the “Three-Foot” Rule. The Three-Foot Rule obligates drivers to allow three feet between their car and a bicycle when passing.

### SUMMARY

The invention provides a device, which is attachable to a bicycle and extends out laterally from the bicycle in a direction toward or into a lane of traffic. The device may be approximately three feet in length and cylindrical in shape. The device serves as a reminder of the leeway that must be given between a bicycle and a passing car, and deters drivers of passing automobiles from encroaching within three feet of the bicycle to which the device is attached. The device is constructed of a flexible polymer material, preferably polyethylene foam. The flexible construction allows the device to flex upon impact by a passing vehicle, thereby preventing substantial effect upon the trajectory of the bicycle and preventing damage to the vehicle. The device can be designed in two parts which can separate in the unlikely event that the end becomes attached to a passing vehicle.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a side elevational view illustrating the invention in accordance with an embodiment thereof.

FIG. 3 shows a side elevational view illustrating the invention in accordance with a second embodiment thereof.

FIG. 3 shows a side elevational view illustrating the invention in accordance with a third embodiment thereof.

### DETAILED DESCRIPTION

Reference will now be made in detail to the preferred embodiments of the present invention, examples of which are illustrated in the accompanying drawings.

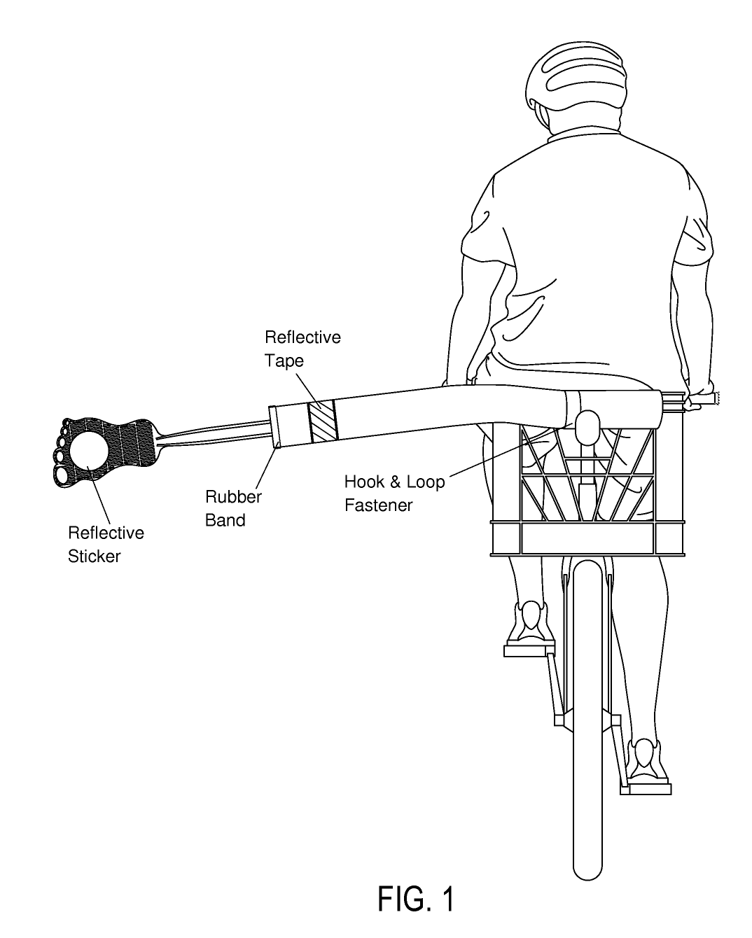

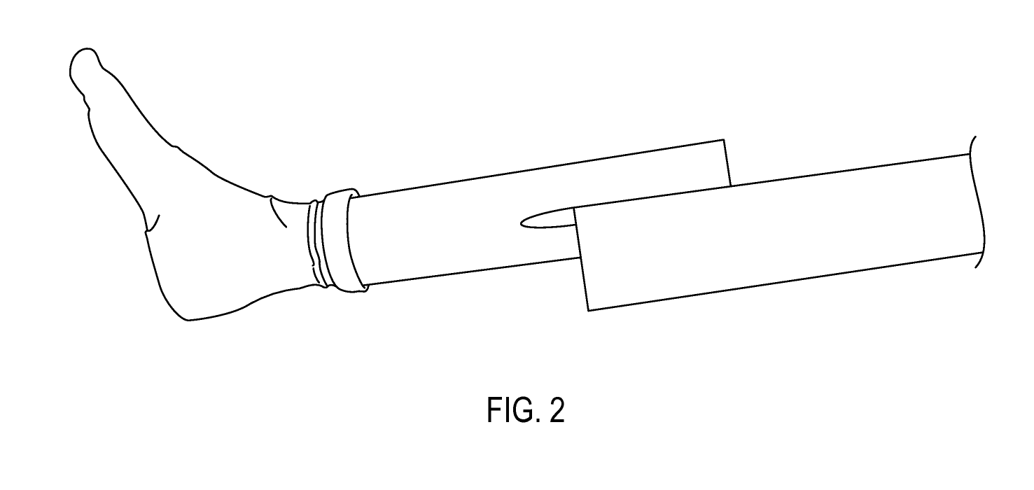

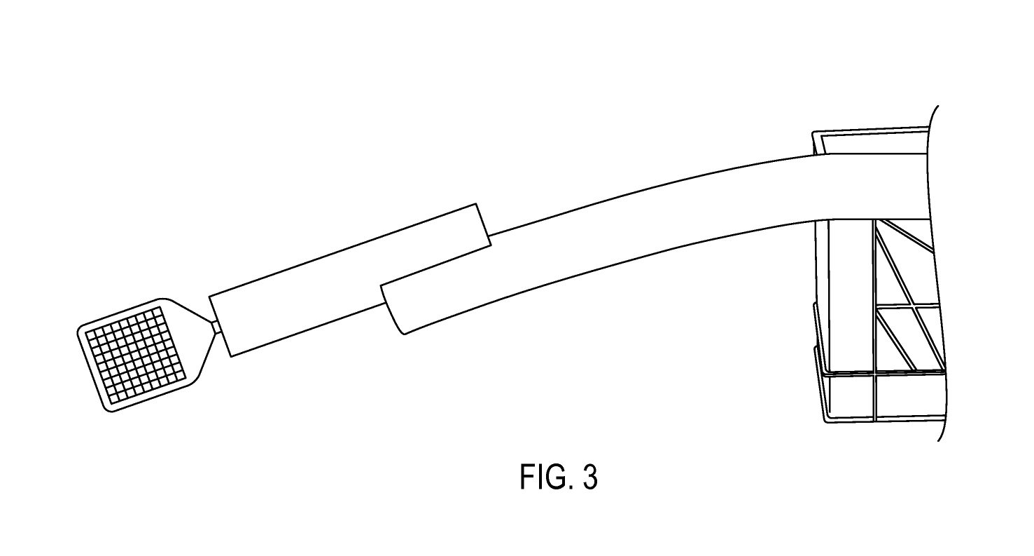

With reference to FIGS. 1-3, the invention in one embodiment provides a cylindrical polymer foam tube which is attachable to a bicycle and extends out laterally from the bicycle in a direction toward or into a lane of traffic.

The device is preferably approximately three feet in length. The device is constructed of a flexible polymer material, preferably polyethylene foam of the type used for swimming pool floats. The flexible construction allows the device to absorb the impact by a passing vehicle, thereby preventing substantial effect of such impact upon the trajectory of the bicycle and preventing damage to the vehicle. The flexible construction is also firm enough to maintain the appropriate distance from the bicycle.

Assembly and attachment of the device to a bicycle may be accomplished as follows. First, the user identifies a part of the rear of the bike, rack, back of seat, etc. that has a horizontal bar. The user then makes a slit in one end of the noodle and slip the float over that part of the bike, so that the float (approximately 2 feet) is sticking out to the left of the bike (as you face forward); i.e. into the lane of traffic, if the rider is riding on the right. This would be reversed if the rider is setting up the device for use in the United Kingdom. The user uses the ‘hook and loop’ strip to hold the noodle to the bike. The user attaches the strip of adhesive reflective tape near the other end of the noodle (the end that will stick out to the left of the bike. The tape is long enough for the ends to overlap, which will assure that the reflective tape will stick to the float. The user places one round adhesive reflective sticker on one or both sides of the “foot” of the fly swatter. The user then slips the handle of the fly swatter about three inches into the end of the float (the end with the reflective tape around it), so that the “foot” is vertical, allowing the reflector to be seen by approaching cars. A rubber band is placed over the end of the noodle where the fly swatter is inserted to provide a tighter grip of the noodle on the swatter.

The device serves as a reminder to drivers of passing automobiles of the leeway that must be given between a bicycle and a passing car, and deters such drivers from encroaching within three feet of the bicycle to which the device is attached.

Reflective tape and/or light diodes attached to the device will increase visibility at night. As shown in FIG. 2, for added safety the device is made of two interlocking parts; a foam tubular part and an outer plastic part that is inserted into the tubular part. If the outer part is dragged by a car, the two parts will separate, preventing the bicycle from being pulled by the car. The interlocking parts of the tube are such that a car impacting and attaching to the device from either direction will separate the parts easily with motion.

The decorative foot, fly swatter, or fly swatter in the shape of a foot at the end of the tube represents a pun on the word “shoo” in the name of the device.

While the invention has been particularly shown and described with reference to a preferred embodiment thereof, it will be understood by those skilled in the art that various changes in form and details may be made therein without departing from the spirit and scope of the invention.

1. A system attachable to a bicycle for serving as a reminder of the leeway that must be given between a bicycle and a passing car, and for deterring drivers of passing automobiles from encroaching within three feet of the bicycle to which the device is attached, comprising:
an elongated member having an attachment mechanism configured to be attached to a bicycle such that the member extends out laterally from the bicycle in a direction toward or into a lane of traffic;
the elongated member being constructed of a flexible polymer material so as to allow flexing upon impact by a passing vehicle, thereby preventing substantial effect upon the trajectory of the bicycle and preventing damage to the vehicle,
the elongated member being in two parts which can separate in the unlikely event that the end becomes attached to a passing vehicle.

2. The system according to claim 1, wherein the elongated member is approximately three feet in length.

3. The system according to claim 1, wherein the elongated member is cylindrical in shape.

4. The system according to claim 1, wherein the elongated member comprises polyethylene foam.
